(19) United States
(12) Patent Application Publication
(10) Pub. No.: US 2026/0252140 A1
(43) Pub. Date: Aug. 27, 2026

(54) SLIDE WINDING DISPLAY DEVICE

(71) Applicants: Chengdu BOE Optoelectronics Technology Co., Ltd., Chengdu, Sichuan (CN); BOE Technology Group Co., Ltd., Beijing (CN); Beijing BOE Technology Development Co., Ltd., Beijing (CN)

(72) Inventors: Xiaolin LIU, Beijing (CN); Hong ZHU, Beijing (CN); Yue LEI, Beijing (CN)

(73) Assignees: Chengdu BOE Optoelectronics Technology Co., Ltd., Chengdu, Sichuan (CN); BOE Technology Group Co., Ltd., Beijing (CN); Beijing BOE Technology Development Co., Ltd., Beijing (CN)

(21) Appl. No.: 18/861,317

(22) PCT Filed: Apr. 25, 2023
(86) PCT No.: PCT/CN2023/090688

§ 371 Date: Oct. 29, 2024

(51) Int. Cl. G06F 1/16

(52) U.S. Cl. CPC G06F 1/1624; G06F 1/1652; G06F 1/1681

(57) ABSTRACT

A slide winding display device includes a stationary housing, at least one sliding housing, at least one elastic assembly, and a snap-fit connecting assembly. The sliding housing is slidably connected to an edge of the stationary housing, where the edge of the stationary housing extends along a first direction. The elastic assembly includes a first elastic member, one end of the first elastic member abuts against the stationary housing, and another end of the first elastic member abuts against the sliding housing. The snap-fit connecting assembly is configured to connect the sliding housing and the stationary housing.

### TECHNICAL FIELD

The present disclosure relates to the field of display technologies and, specifically, to a slide winding display device.

### BACKGROUND

Flexible display panels have the advantages of being bendable and windable, providing the possibility of designing new forms of display devices. As an application of flexible display panels, slide winding display devices can provide different sizes of screen display area according to user needs.

Most of the existing slide winding display devices are driven by electricity, and the driving force of the slide winding display device is constant when the slide winding display device changes from a tightened state to an unfolded state, but the modulus of the flexible display panel changes with the usage environment, and the constant driving force affects the service life of the flexible display panel.

It should be noted that the information disclosed in the above-described background section is only used for enhancement of understanding in the background of the present disclosure, and thus may include information that does not constitute prior art known to those ordinary skilled in the art.

### SUMMARY

An object of the present disclosure is to overcome the deficiencies in the prior art described above and provide a slide winding display device.

According to an aspect of the present disclosure, there is provided a slide winding display device, including a stationary housing, a sliding housing, an elastic assembly, and a snap-fit connecting assembly. The sliding housing is slidably connected to an edge of the stationary housing, where the edge of the stationary housing extends along a first direction. The elastic assembly includes a first elastic member, one end of the first elastic member abuts against the stationary housing, and another end of the first elastic member abuts against the sliding housing. The snap-fit connecting assembly is configured to connect the sliding housing and the stationary housing.

In an embodiment of the present disclosure, the slide winding display device includes two sliding housings and at least one pair of elastic assemblies, the two sliding housings are slidably connected to two edges of the stationary housing that extend along the first direction, the pair of elastic assemblies includes two elastic assemblies, first elastic members of the two elastic assemblies have ends abutting against the stationary housing, and other ends of the first elastic members of the two elastic assemblies abut against the two sliding housings respectively.

In an embodiment of the present disclosure, the two elastic assemblies of the pair of elastic assemblies are arranged along the first direction and are staggered from each other along a second direction, and the second direction is perpendicular to the first direction.

In an embodiment of the present disclosure, the slide winding display device includes a plurality of pairs of elastic assemblies, the plurality of pairs of elastic assemblies are arranged in sequence along the second direction, every two of the pairs of elastic assemblies form a group, two pairs of elastic assemblies in one group of elastic assemblies are arranged symmetrically about a centerline of the stationary housing, and the centerline of the stationary housing extends along the first direction.

In an embodiment of the present disclosure, the stationary housing is provided with a mounting cavity, the elastic assembly is arranged in the mounting cavity, the elastic assembly further includes a mounting base and a guide pillar, the mounting base is arranged in the mounting cavity, the guide pillar is fixed on the mounting base and extends along the first direction, the first elastic member is assembled on the guide pillar, and the first elastic member passes through a through hole provided in the mounting base and abuts against the sliding housing.

In an embodiment of the present disclosure, the slide winding display device further includes a spring base, the first elastic member is at least partially arranged in the spring base, the spring base extends into the mounting base, one end of the spring base away from the sliding housing is provided with a stop part, and the stop part has a larger size than the through hole.

In an embodiment of the present disclosure, the snap-fit connecting assembly includes a first snap-fit connecting member and a second snap-fit connecting member, one of the first snap-fit connecting member and the second snap-fit connecting member is arranged on one of the sliding housings, and another one of the first snap-fit connecting member and the second snap-fit connecting member is arranged on the stationary housing or another one of the sliding housings.

In an embodiment of the present disclosure, the first snap-fit connecting member is fixedly connected to the sliding housing, the snap-fit connecting assembly further includes a push rod, the push rod passes through a side wall of the stationary housing, the second snap-fit connecting member is rotatably connected to the stationary housing, one end of the second snap-fit connecting member away from the first snap-fit connecting member is slidably connected to the push rod, and the second snap-fit connecting member is capable of rotating relative to the stationary housing when the second snap-fit connecting member slides.

In an embodiment of the present disclosure, the snap-fit connecting assembly further includes a second elastic member, a first stopper and a second stopper, the second elastic member is provided between the first stopper and the second stopper and abuts against the first stopper and the second stopper, the first stopper is fixedly connected to the stationary housing, the second stopper is fixedly connected to the push rod, the second stopper is provided with a protruding part, and the protruding part protrudes from the side wall of the stationary housing.

In an embodiment of the present disclosure, the snap-fit connecting assembly includes two first snap-fit connecting members and two second snap-fit connecting members, the two second snap-fit connecting members are slidably connected to a same position of the push rod, and the two second snap-fit connecting members are arranged on two sides of the push rod along the first direction.

In an embodiment of the present disclosure, the first snap-fit connecting member includes a first fixed part, a first connecting part and a first snap-fit connecting part, the first fixed part and the first connecting part extend along the first direction, the first snap-fit connecting part extends along a second direction, the first fixed part and the first snap-fit connecting part form a first slot, the second snap-fit connecting member includes a second fixed part, a second connecting part and a second snap-fit connecting part, the second fixed part and the second connecting part extend along the first direction, the second snap-fit connecting part extends along the second direction, the second fixed part and the second snap-fit connecting part form a second slot, a side of the first snap-fit connecting part away from the first fixed part is provided with a first inclined surface, and a side of the second snap-fit connecting part away from the second fixed part is provided with a second inclined surface matched with the first inclined surface.

In an embodiment of the present disclosure, the slide winding display device further includes a support mechanism, the support mechanism includes at least one folding connection rod assembly, the folding connection rod assembly includes a plurality of connection rods hingedly connected to each other, and connection rods arranged at two ends of the folding connection rod assembly are connected to the stationary housing and the sliding housing respectively.

In an embodiment of the present disclosure, the folding connection rod assembly further includes a torsion spring and a rivet, two adjacent ones of the connection rods are rotatably connected to the rivet, the torsion spring is assembled on the rivet, and the torsion spring is relaxed when an angle between the two adjacent ones of the connection rods is increased.

In an embodiment of the present disclosure, the slide winding display device further includes a guide rail arranged along the first direction, and the rivet is slidably connected in the guide rail.

In an embodiment of the present disclosure, the support mechanism includes a plurality of folding connection rod assemblies, and the plurality of folding connection rod assemblies are arranged in sequence along the second direction in a uniform manner.

In an embodiment of the present disclosure, the slide winding display device further includes a flexible display panel, the flexible display panel is partially fixed on a surface of the stationary housing away from the elastic assembly, and is wound along the support mechanism to a surface of the stationary housing close to the elastic assembly, and the flexible display panel is capable of sliding relative to the sliding housing.

In an embodiment of the present disclosure, the slide winding display device further includes a flexible support plate, the flexible support plate is fixed on the flexible display panel, and the flexible support plate is partially arranged between the support mechanism and the flexible display panel, and is partially arranged between the sliding housing and the flexible display panel.

In an embodiment of the present disclosure, the snap-fit connecting assembly includes a first snap-fit connecting member and a second snap-fit connecting member, one of the first snap-fit connecting member and the second snap-fit connecting member is arranged on one of edges of the flexible display panel that are along the second direction, and another one of the first snap-fit connecting member and the second snap-fit connecting member is arranged on the stationary housing or another one of the edges of the flexible display panel that are along the second direction.

It should be understood that the above general description and the subsequent detailed description are exemplary and explanatory only, and do not limit the present disclosure.

### BRIEF DESCRIPTION OF THE DRAWINGS

The accompanying drawings herein, which are incorporated into and form a part of the specification, illustrate embodiments consistent with the present disclosure, and are used in conjunction with the specification to explain the principles of the present disclosure. It is apparent that the accompanying drawings in the following description are only some of the embodiments of the present disclosure, and that other accompanying drawings can be obtained based on these accompanying drawings without creative labor for those ordinary skilled in the art.

FIG. 1 is a schematic diagram of a back surface of a slide winding display device when the slide winding display device slides to unfold involved in an embodiment of the present disclosure.

FIG. 2 is a schematic diagram of a back surface of a slide winding display device when the slide winding display device slides to tighten involved in an embodiment of the present disclosure.

FIG. 3 is a schematic diagram of another back surface of a slide winding display device when the slide winding display device slides to tighten involved in an embodiment of the present disclosure.

FIG. 4 is a schematic diagram of another back surface of a slide winding display device when the slide winding display device slides to unfold involved in an embodiment of the present disclosure.

FIG. 5 a schematic diagram of yet another back surface of a slide winding display device when the slide winding display device slides to unfold involved in an embodiment of the present disclosure.

FIG. 6 is a schematic diagram of a structure and installation of an elastic assembly involved in an embodiment of the present disclosure.

FIG. 7 is a schematic diagram of installation of a snap-in connecting assembly involved in an embodiment of the present disclosure.

FIG. 8 is a schematic diagram of a structure of a snap-in connecting assembly involved in an embodiment of the present disclosure.

FIG. 9 is an exploded view of a snap-in connecting assembly involved in an embodiment of the present disclosure.

FIG. 10 is a schematic diagram of a structure of a folding connection rod assembly involved in an embodiment of the present disclosure.

FIG. 11 is a schematic diagram of a front surface of a slide winding display device when the slide winding display device slides to tighten involved in an embodiment of the present disclosure.

FIG. 12 is a schematic diagram of a front surface of a slide winding display device when the slide winding display device slides to unfold involved in an embodiment of the present disclosure.

### DESCRIPTION OF REFERENCE NUMERALS

1—stationary housing, 11—support plate, 12—guide plate, 13—mounting cavity, 14—guide rail, 2—sliding housing, 21—sliding plate, 22—connecting arm, 23—connecting plate, 3—elastic assembly, 31—mounting base, 32—guide pillar 33—first elastic member, 34—spring base, 341—stop part, 4—snap-fit connecting assembly, 41—first snap-fit connecting member, 411—first fixed part, 412—first connecting part, 413—first snap-fit connecting part, 414—first slot, 415—first inclined surface, 42—second snap-fit connecting member, 421—second fixed part, 422—second connecting part, 423—second snap-fit connecting part, 424—second slot, 425—oval-shaped hole, 426—second inclined surface, 43—push rod, 431—first connecting hole, 44—second elastic member, 45—first stopper, 451—connecting structure, 46—second stopper, 461—protruding part, 47—pin, 5—folding connection rod assembly, 51—connection rod, 511—connecting part, 52—torsion spring, 53—rivet, 6—flexible display panel, 7—flexible support plate.

### DETAILED DESCRIPTION

Exemplary embodiments are now described more comprehensively with reference to the accompanying drawings. However, the exemplary embodiments are capable of being implemented in a variety of forms, and should not be construed as being limited to the embodiments set forth herein. Rather, the provision of these embodiments allows for the present disclosure to be comprehensive and complete, and conveys the idea of the exemplary embodiments in a comprehensive manner to those skilled in the art. The same reference numerals in the drawings indicate the same or similar structures, and therefore their detailed descriptions will be omitted. In addition, the accompanying drawings are only schematic illustrations of the present disclosure, and are not necessarily drawn to scale.

Although relative terms such as “up” and “down” are used in this specification to describe a relative relationship between one component and another component indicated in the drawings, these terms are used in this specification only for convenience, e.g., in accordance with the direction of the example described in the accompanying drawing. It can be understood that if the device indicated in the drawing is flipped upside down, the component described as being “up” will become the component described as being “down”. When a certain structure is “on” another structure, it may mean that the certain structure is integrally formed on the another structure, or that the certain structure is “directly” arranged on the another structure, or that the certain structure is “indirectly” arranged on the another structure through yet another structure.

The terms “a”, “an”, “the”, “said”, and “at least one” are used for indicating an existence of one or more elements/components/etc. ; and the terms “include” and “have” are used for indicating an open-ended inclusion and mean that there may be additional elements/components/etc. in addition to the listed elements/components/etc. The terms “first”, “second” and “third”, etc. are used merely as markers but not as quantitative limitations to the objects thereof.

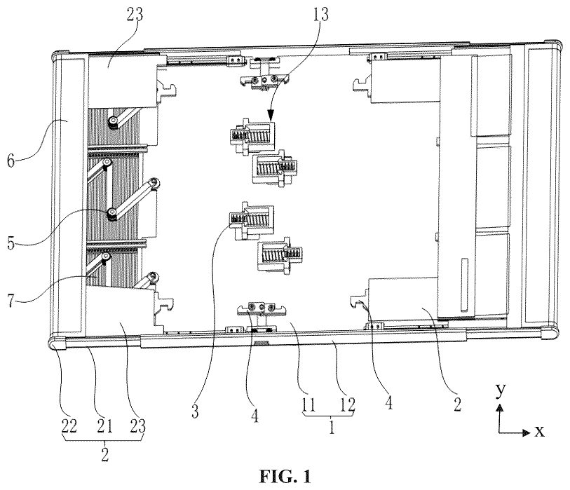

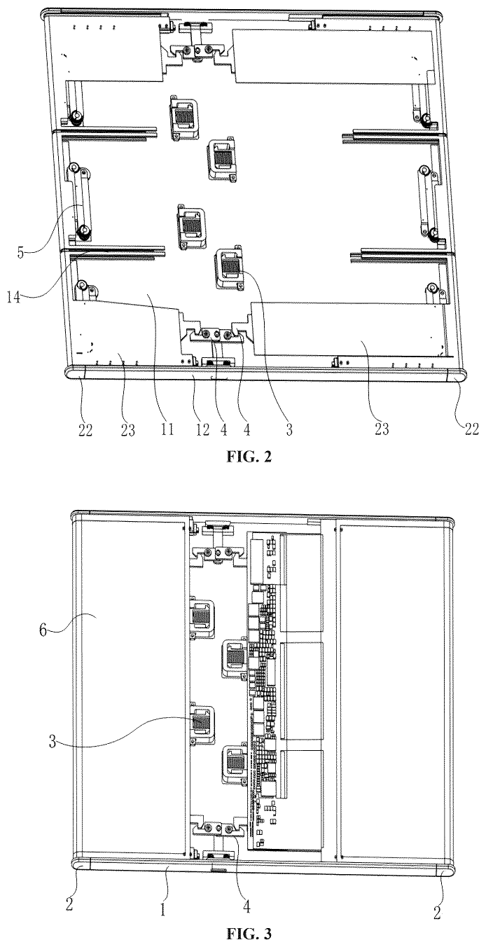

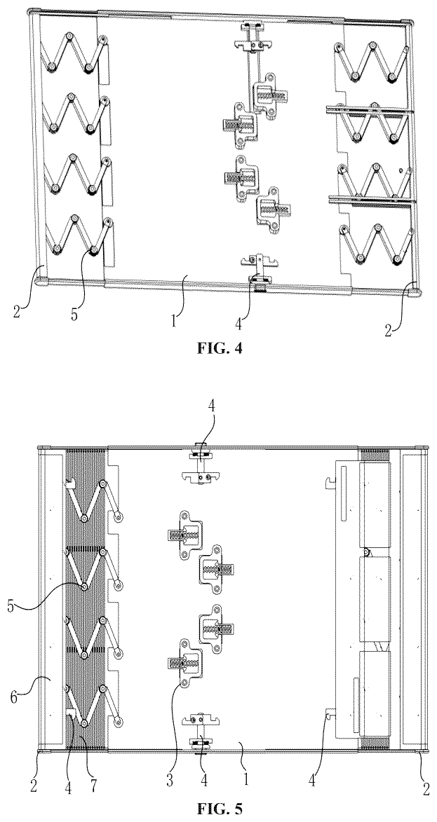

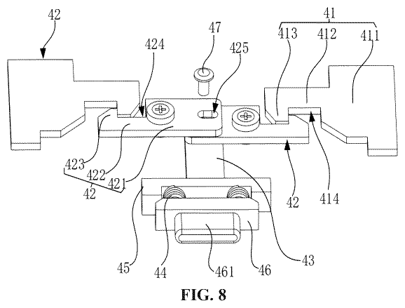

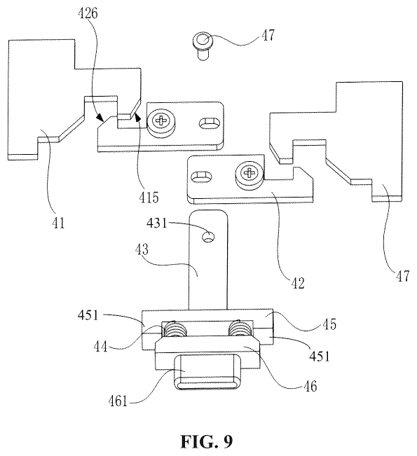

The embodiments of the present disclosure provide a slide winding display device. As shown in FIGS. 1 to 12, the slide winding display device includes a stationary housing 1, a sliding housing 2, an elastic assembly 3, and a snap-fit connecting assembly 4. The sliding housing 2 is slidably connected to an edge of the stationary housing 1, where the edge of the stationary housing 1 extends along a first direction. The elastic assembly 3 includes a first elastic member 33, one end of the first elastic member 33 abuts against the stationary housing 1, and another end of the first elastic member 33 abuts against the sliding housing 2. The snap-fit connecting assembly 4 is configured to connect the sliding housing 2 and the stationary housing 1.

When the snap-fit connecting assembly 4 connects the sliding housing 2 to the stationary housing 1, the first elastic member 33 of the elastic assembly 3 is in a compressed state. When the snap-in connecting assembly 4 separates the sliding housing 2 from the stationary housing 1, the first elastic member 33 pushes the sliding housing 2 to slide relative to the stationary housing 1, causing the sliding housing 2 to move away from the stationary housing 1 along the first direction and drive the flexible display panel 6 to unfold, which increases the display area of the flexible display panel 6. When the modulus of the flexible display panel changes, the driving force provided by the first elastic member 33 changes simultaneously, causing that during the unfolding process of the sliding winding display device, a driving force adapted to the modulus of the flexible display panel can always be provided, and the influence on the service life of the flexible display panel is avoided.

The slide winding display device involved in the embodiments of the present disclosure is described in detail below in connection with specific embodiments.

As shown in FIGS. 1 to 5, the slide winding display device includes a stationary housing 1. The stationary housing 1 is a rectangular structure. The stationary housing 1 includes a support plate 11 and two guide plates 12. The support plate 11 includes two first edges parallel to each other and two second edges parallel to each other. The first edge extends along a first direction, the second edge extends along a second direction, and the first edge has a greater length than the second edge. The two guide plates 12 are arranged on the two first edges of the support plate 11 respectively. The plane in which the guide plate 12 is located is perpendicular to the plane in which the support plate 11 is located. It should be noted that the second direction is perpendicular to the first direction, the third direction is perpendicular to the first direction and the second direction, the first direction is the x direction in FIG. 1, and the second direction is the y direction in FIG. 1.

The slide winding display device further includes two sliding housings 2. The two sliding housings 2 are arranged on two sides of the stationary housing 1 along the first direction, i.e., the two sliding housings 2 are arranged close to the two second edges of the stationary housing 1 respectively. The sliding housing 2 includes sliding plates 21, a connecting arm 22 and connecting plate 23. The connecting arm 22 extends along the second direction. The sliding plate 21 extends along the first direction. The sliding plates 21 are arranged at two ends of the connecting arm 22 and extend towards a side close to the stationary housing 1. The connecting plate 23 is arranged between the two connecting arms 22 and extends along the first direction towards a side close to the stationary housing 1. Each of the two guide plates 12 of the stationary housing 1 is provided with a track, and the two sliding plates 21 are slidably connected in the tracks.

The slide winding display device further includes a plurality of pairs of elastic assemblies 3. The plurality of pairs of elastic assemblies 3 are arranged in sequence along the second direction. Each pair of elastic assemblies 3 includes two elastic assemblies 3, and the two elastic assemblies 3 are arranged symmetrically about a centerline of the stationary housing 1, where the centerline of the stationary housing 1 extends along the second direction. In order to avoid mutual interference between the two elastic assemblies 3 and to reduce the size of the mounting areas of the elastic assemblies 3 in the first direction, the two elastic assemblies 3 of one pair of elastic assemblies 3 are arranged along the first direction.

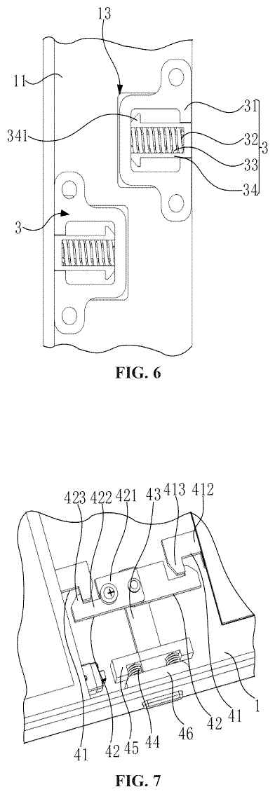

As shown in FIG. 6, the stationary housing 1 is provided with a mounting cavity 13, and the elastic assembly 3 is arranged in the mounting cavity 13. The elastic assembly 3 includes a mounting base 31, a first elastic member 33 and a guide pillar 32. The mounting base 31 is arranged in the mounting cavity 13. The guide pillar 32 is fixed on the mounting base 31 and extends along the first direction. Two mounting bases 31 in one pair of elastic assemblies 3 are provided back to back, so that extension directions of two guide pillars 32 in one pair of elastic assemblies 3 are opposite to each other in the first direction. The first elastic member 33 may be a spring. The first elastic member 33 is assembled on the guide pillar 32 in a sleeving manner. The mounting base 31 is provided with a through hole. The center of the through hole is located on the centerline of the guide pillar 32, and the first elastic member 33 passes through the through hole and abuts against the sliding housing 2. It should be noted that “abut against” means that the first elastic member 33 is in close contact with the sliding housing 2. The first elastic member 33 has a certain amount of deformation when the first elastic member 33 abuts against the sliding housing 2.

In order to prevent the first elastic member 33 from being separated from the guide pillar 32, the slide winding display device further includes a spring base 34. The spring base 34 passes through the through hole and extends into the mounting base 31. One end of the spring base 34 away from the sliding housing 2 is provided with a stop part 341. The stop part 341 has a larger size than the through hole. One end of the first elastic member 33 is always in contact with the bottom of the mounting base 31, and another end of the first elastic member 33 is always in contact with the bottom of the spring base 34.

As shown in FIGS. 7 to 9, the slide winding display device further includes a snap-fit connecting assembly 4. The snap-fit connecting assembly 4 includes a push rod 43, a first snap-fit connecting member 41 and a second snap-fit connecting member 42. The push rod 43 passes through a side wall of the stationary housing 1 and extends into a surface of the stationary housing 1 close to the elastic assembly 3. The middle portion of the second snap-fit connecting member 42 is rotatably connected to the stationary housing 1. The adapter positions of two second snap-fit connecting members 42 are located on two sides of the push rod 43 along first direction. The portions of the second snap-fit connecting members 42 located between the two adapter positions are slidably connected to the push rod 43, i.e., the end of the second snap-fit connecting member 42 away from the first snap-fit connecting member 41 is slidably connected to the push rod 43, and the two second snap-fit connecting members 42 are slidably connected to the same position of the push rod 43. The first snap-fit connecting member 41 is fixed on the connecting plate 23 of the sliding housing 2. When the two sliding housings 2 move towards the direction close to the stationary housing 1, the first snap-fit connecting member 41 approaches the second snap-fit connecting member 42.

The snap-fit connecting assembly 4 further includes a pin 47. The second snap-fit connecting member 42 is provided with an oval-shaped hole that extends along the first direction. The push rod 43 is provided with a first connecting hole 431. The pin 47 passes through the oval-shaped hole and the first connecting hole 431, and connects the second snap-fit connecting member 42 to the push rod 43. This makes the pin 47 to slide and rotate within the oval-shaped hole 425 when the second snap-fit connecting member 42 rotates relative to the stationary housing, which defines the rotation trajectory and stroke of the second snap-fit connecting member 42. It should be noted that the oval-shaped hole 425 includes two straight section hole walls parallel to each other, and an arc-shaped hole wall connecting two ends of the two straight section hole walls.

In order to ensure that the push rod 43 can effectively rebound after pushing the second snap-fit connecting member 42, the snap-fit connecting assembly 4 further includes a second elastic member 44, a first stopper 45 and a second stopper 46. The second elastic member 44 is provided between the first stopper 45 and the second stopper 46 and abuts against the first stopper 45 and the second stopper 46. The first stopper 45 is fixedly connected to the stationary housing 1. The second stopper 46 is fixedly connected to the push rod 43. The second stopper 46 is provided with a protruding part 461. The protruding part 461 protrudes from the side wall of the stationary housing 1. The first stopper 45 includes connecting structures 451. The first stopper 45 is connected to the stationary housing 1 through two connecting structures 451. The second stopper 46 is arranged between the two connecting structures 451. The size of the first stopper 45 is less than or equal to the distance between the two connecting structures 451.

The first snap-fit connecting member 41 is a first snap-fit hook. The second snap-fit connecting member 42 is a second snap-fit hook. The first snap-fit connecting member 41 includes a first fixed part 411, a first connecting part 41 and a first snap-fit connecting part 413. Both the first fixed part and the first connecting part 412 extend along the first direction. The first snap-fit connecting part 413 extends along the second direction. The size of the first connecting part 412 in the second direction is smaller than the size of the first fixed part in the second direction. The first fixed part and the first snap-fit connecting part 413 form a first slot 414.

The second snap-fit connecting member 42 includes a second fixed part 421, a second connecting part 422, and a second snap-fit connecting part 423. Both the second fixed part 421 and the second connecting part 422 extend along the first direction. The second snap-fit connecting part 423 extends along the second direction. The size of the second connecting part 422 in the second direction is smaller than the size of the second fixed part 421 in the second direction. The second fixed part 421 and the second snap-fit connecting part 423 form a second slot 424. When the second snap-fit connecting member 42 is connected to the first snap-fit connecting member 41, the first snap-fit connecting part 413 is located in the second slot 424, and the second snap-fit connecting part 423 is located in the second slot 424.

A side of the first snap-fit connecting part 413 away from the first fixed part 411 is provided with a first inclined surface 415. A side of the second snap-fit connecting part 423 away from the second fixed part 421 is provided with a second inclined surface 426 that is matched with the first inclined surface 415. It should be noted that the second snap-fit connecting member 42 is connected to the push rod 43 and the stationary housing 1 through the second fixed part 421.

In other realizable embodiments, the first snap-fit connecting member 41 may be provided on one of the sliding housings 2, and the first snap-fit connecting member 41 may be fixedly connected to that sliding housing 2; and the second snap-fit connecting member 42 may be provided on another one of the sliding housings 2, the push rod 43 passes through a side wall of this sliding housing 2, the adapter position of the second snap-fit connecting member 42 is located on a side of the push rod 43 that is close to the first snap-fit connecting member 41 along the first direction, the middle portion of the second snap-fit connecting member 42 is rotatably connected to this sliding housing 2, and one end of the second snap-fit connecting member 42 away from the first snap-fit connecting member 41 is slidably connected to the push rod 43. The structures and setting directions of the first snap-fit connecting member 41 and the second snap-fit connecting member 42 are the same as those mentioned above and will not be repeated herein.

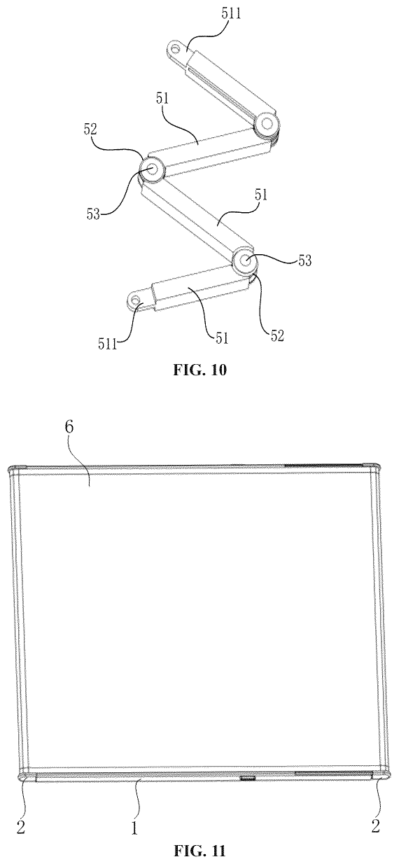

As shown in FIG. 10, the slide winding display device further includes a support mechanism. The support mechanism includes a plurality of folding connection rod assemblies 5. The folding connection rod assembly 5 includes a plurality of connection rods 51 hingedly connected to each other. Connection rods 51 arranged at two ends of each of the folding connection rod assemblies 5 are connected to the stationary housing 1 and the sliding housing 2 respectively. When the sliding housing 2 moves away from the stationary housing 1 along the first direction, the angle between two adjacent connection rods 51 is gradually increased, and the folding connection rod assembly 5 is gradually unfolded.

The folding connection rod assembly 5 further includes a rivet 53. Two ends of the connection rod 51 are provided with connecting parts 511. The connecting parts 511 is provided with a second connecting hole. The rivet 53 passes through the second connecting hole to connect two adjacent connection rods 51 together. The two connection rods 51 are capable of rotating relative to the rivet 53 to change the angle between them. It can be understood that a plurality of connection rods 51 are hinged together by a plurality of rivets 53.

The folding connection rod assembly 5 further includes a torsion spring 52. The torsion spring 52 is assembled on the rivet 53 in a sleeving manner. When the snap-fit connecting assembly 4 separates the sliding housing 2 from the stationary housing 1, the sliding housing 2 slides towards the direction away from the stationary housing 1, the angle between two adjacent connection rods 51 is gradually increased, and the torsion spring 52 is gradually relaxed and squeezes the two adjacent connection rods 51, causing that the support mechanism is gradually changed from the tightened state to the supporting state. When the sliding housing 2 is manually pushed to slide towards the direction close to the stationary housing 1, two adjacent connection rods 51 squeeze the torsion spring 52, causing that the torsion spring 52 is gradually tightened, the angle between the two adjacent connection rods 51 is gradually reduced, and the support mechanism is gradually changed from the supporting state to the tightened state.

Referring again to FIGS. 1 to 5, the slide winding display device further includes a flexible display panel 6. The flexible display panel 6 is partially fixed on a surface of the stationary housing 1 away from the elastic assembly 3, and is wound along the support mechanism to a surface of the stationary housing 1 close to the elastic assembly 3. The flexible display panel 6 is capable of sliding relative to the sliding housing 2. The slide winding display device further includes a flexible support plate 7. The flexible support plate 7 is fixed on the flexible display panel. The flexible support plate 7 is partially arranged between the support mechanism and the flexible display panel, and is partially arranged between the sliding housing 2 and the flexible display panel. Because the flexible display panel 6 slides synchronously with the sliding housing 2, the first snap-fit connecting 41 may also be directly connected to the flexible display panel 6.

The shape and size of the flexible support plate 7 is matched with those of the flexible display panel 6, and the flexible support plate 7 and the flexible display panel 6 can be fixed together. When the sliding housing 2 slides towards the direction away from the stationary housing 1, the flexible support plate 7 slides relative to the connecting arm 22, causing that two free ends disposed on the flexible support plate 7 are far away from each other, and thus a portion of the flexible display panel 6 is driven to slide from the non-display surface to the display surface, which makes the display area of the slide winding display device increased.

When the sliding housing 2 is manually pushed to slide towards the direction close to the stationary housing 1, the flexible support plate 7 slides relative to the connecting arm 22 when the sliding housing 2 slides towards the direction away from the stationary housing 1, causing two free ends disposed on the flexible support plate 7 to be close to each other, and thus a portion of the flexible display panel 6 is driven to slide from the display surface to the non-display surface, which makes the display area of the slide winding display device reduced.

It should be noted that the flexible display device further includes other necessary parts and compositions in addition to the display panel, specifically, for example, a circuit board, a power supply line, etc. may be included. Those skilled in the art may perform supplementing accordingly according to the specific using requirements of the display device, which will not be repeated herein. The slide winding display device may be a traditional electronic device, for example, a mobile phone, a computer, a television, and a camcorder, or it may be an emerging wearable device, such as a virtual reality device and an augmented reality device, which will not be listed one by one herein.

In order to ensure that the folding connection rod assembly 5 is unfolded along the first direction, the slide winding display device further includes a guide rail 14 arranged along the first direction. The guide rail 14 is arranged along the first direction. The guide rail 14 may be fixedly connected to the stationary housing 1. The sliding housing 2 is provided with a slider corresponding to the guide rail 14. The slider is fixedly connected to the sliding housing 2. The slider is slidably connected in the guide rail 14, defining the sliding direction of the connecting plate 23 relative to the stationary housing 1, thereby defining the sliding trajectory of the middle portion of the flexible display panel, which enables that the flexible display panel is always in a flat state during unfolding processes.

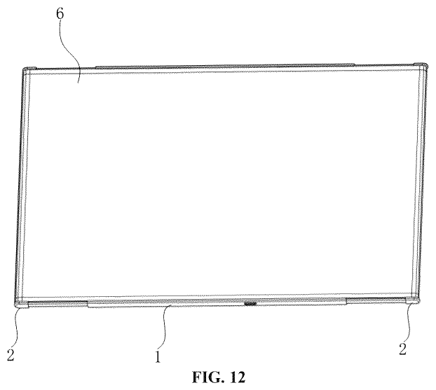

As shown in FIGS. 11 and 12, the working process of the slide winding display device is described in detail herein in conjunction with the specific structure of the slide winding display device illustrated in FIGS. 1 to 10.

The sliding housing 2 is manually pushed to move along the first direction towards the direction close to the stationary housing 1, the angle between two adjacent connection rods 51 in the folding connection rod assembly 5 is gradually reduced, the torsion spring 52 is gradually tightened, and at the same time, the distance between the sliding housing 2 and the stationary housing 1 is getting smaller and smaller. When the connecting plate 23 comes into contact with the spring base 34, the first elastic member 33 is compressed, the spring base 34 slides along the inner wall of the stationary housing 1, and the first inclined surface 415 of the first snap-fit connecting member 41 slides along the second inclined surface 426 of the second snap-fit connecting member 42. When the spring base 34 moves to contact the bottom of the mounting base 31, the first snap-fit connecting member 41 slides into the second slot 424 of the second snap-fit connecting member 42, the display area of the flexible display panel is gradually reduced, and the slide winding display device is changed from the unfolded state to the tightened state.

When the protruding part 461 on the second stopper 46 is pressed, the push rod 43 pushes the first snap-fit connecting member 41 to rotate along the pin 47, causing that the first snap-fit connecting member 41 is separated from the second slot 424 of the second snap-fit connecting member 42, and the connecting plate 23 is separated from the spring base 34, at which time the first elastic member 33 begins to be relaxed. When the first elastic member 33 pushes the spring base 34 to move along the first direction towards the direction away from the stationary housing 1, the angle between two adjacent connection rods 51 is caused to be gradually increased, and the torsion spring 52 is caused to be gradually relaxed. When the stop part 341 of the spring base 34 abuts against the mounting base 31, the torsion spring 52 continues to be relaxed, causing that the angle between two adjacent connection rods 51 continues to be increased, the sliding housing 2 is pushed to continue to move towards the direction away from the stationary housing 1, and the slide winding display device is changed from the tightened state to the unfolded state.

After considering the specification and practicing the invention disclosed herein, those skilled in the art will easily come up with other implementation solutions of the present disclosure. The purpose of the present application is to cover any variations, uses or adaptations of the present disclosure, and these variations, uses or adaptations follow the general principles of the present disclosure and include common knowledge or commonly used technical means in the technical field that is not disclosed in the present disclosure. The specification and embodiments are only considered exemplary, and the true scope and spirit of the present disclosure are indicated by the accompanying claims.

1. A slide winding display device, comprising:
a stationary housing;
at least one sliding housing, slidably connected to an edge of the stationary housing, wherein the edge of the stationary housing extends along a first direction;
at least one elastic assembly, wherein the elastic assembly comprises a first elastic member, one end of the first elastic member abuts against the stationary housing, and another end of the first elastic member abuts against the sliding housing; and
a snap-fit connecting assembly, configured to connect the sliding housing and the stationary housing.

2. The slide winding display device according to claim 1, wherein the at least one sliding housing comprises two sliding housings, the at least one elastic assembly comprises at least one pair of elastic assemblies, the two sliding housings are slidably connected to two edges of the stationary housing that extend along the first direction, the pair of elastic assemblies comprises two elastic assemblies, first elastic members of the two elastic assemblies have first ends abutting against the stationary housing, and second ends of the first elastic members of the two elastic assemblies abut against the two sliding housings respectively.

3. The slide winding display device according to claim 2, wherein the two elastic assemblies of the pair of elastic assemblies are arranged along the first direction and are staggered from each other along a second direction, and the second direction is perpendicular to the first direction.

4. The slide winding display device according to claim 3, wherein the at least one elastic assembly comprises a plurality of pairs of elastic assemblies, the plurality of pairs of elastic assemblies are arranged in sequence along the second direction, every two of the pairs of elastic assemblies form a group, two pairs of elastic assemblies in one group of elastic assemblies are arranged symmetrically about a centerline of the stationary housing, and the centerline of the stationary housing extends along the first direction.

5. The slide winding display device according to claim 1, wherein the stationary housing is provided with a mounting cavity, the elastic assembly is arranged in the mounting cavity, the elastic assembly further comprises a mounting base and a guide pillar, the mounting base is arranged in the mounting cavity, the guide pillar is fixed on the mounting base and extends along the first direction, the first elastic member is assembled on the guide pillar, and the first elastic member passes through a through hole provided in the mounting base and abuts against the sliding housing.

6. The slide winding display device according to claim 5, wherein the slide winding display device further comprises a spring base, the first elastic member is at least partially arranged in the spring base, the spring base extends into the mounting base, one end of the spring base away from the sliding housing is provided with a stop part, and the stop part has a larger size than the through hole.

7. The slide winding display device according to claim 2, wherein the snap-fit connecting assembly comprises at least one first snap-fit connecting member and at least one second snap-fit connecting member, one of the first snap-fit connecting member and the second snap-fit connecting member is arranged on one of the sliding housings, and another one of the first snap-fit connecting member and the second snap-fit connecting member is arranged on the stationary housing or another one of the sliding housings.

8. The slide winding display device according to claim 7, wherein the first snap-fit connecting member is fixedly connected to the sliding housing, the snap-fit connecting assembly further comprises a push rod, the push rod passes through a side wall of the stationary housing, the second snap-fit connecting member is rotatably connected to the stationary housing, one end of the second snap-fit connecting member away from the first snap-fit connecting member is slidably connected to the push rod, and the second snap-fit connecting member is capable of rotating relative to the stationary housing when the second snap-fit connecting member slides.

9. The slide winding display device according to claim 8, wherein the snap-fit connecting assembly further comprises a second elastic member, a first stopper and a second stopper, the second elastic member is provided between the first stopper and the second stopper and abuts against the first stopper and the second stopper, the first stopper is fixedly connected to the stationary housing, the second stopper is fixedly connected to the push rod, the second stopper is provided with a protruding part, and the protruding part protrudes from the side wall of the stationary housing.

10. The slide winding display device according to claim 8, wherein the at least one first snap-fit connecting member comprises two first snap-fit connecting members, the at least one second snap-fit connecting member comprises two second snap-fit connecting members, the two second snap-fit connecting members are slidably connected to a same position of the push rod, and the two second snap-fit connecting members are arranged on two sides of the push rod along the first direction.

11. The slide winding display device according to claim 7, wherein the first snap-fit connecting member comprises a first fixed part, a first connecting part and a first snap-fit connecting part, the first fixed part and the first connecting part extend along the first direction, the first snap-fit connecting part extends along a second direction, the first fixed part and the first snap-fit connecting part form a first slot, the second snap-fit connecting member comprises a second fixed part, a second connecting part and a second snap-fit connecting part, the second fixed part and the second connecting part extend along the first direction, the second snap-fit connecting part extends along the second direction, the second fixed part and the second snap-fit connecting part form a second slot, a side of the first snap-fit connecting part away from the first fixed part is provided with a first inclined surface, and a side of the second snap-fit connecting part away from the second fixed part is provided with a second inclined surface matched with the first inclined surface.

12. The slide winding display device according to claim 3, wherein the slide winding display device further comprises a support mechanism, the support mechanism comprises at least one folding connection rod assembly, the folding connection rod assembly comprises a plurality of connection rods hingedly connected to each other, and connection rods arranged at two ends of the folding connection rod assembly are connected to the stationary housing and the sliding housing respectively.

13. The slide winding display device according to claim 12, wherein the folding connection rod assembly further comprises a torsion spring and a rivet, two adjacent ones of the connection rods are rotatably connected to the rivet, the torsion spring is assembled on the rivet, and the torsion spring is relaxed when an angle between the two adjacent ones of the connection rods is increased.

14. The slide winding display device according to claim 13, wherein the slide winding display device further comprises a guide rail arranged along the first direction, and the rivet is slidably connected in the guide rail.

15. The slide winding display device according to claim 12, wherein the at least one folding connection rod assembly comprises a plurality of folding connection rod assemblies, and the plurality of folding connection rod assemblies are arranged in sequence along the second direction in a uniform manner.

16. The slide winding display device according to claim 12, wherein the slide winding display device further comprises a flexible display panel, the flexible display panel is partially fixed on a surface of the stationary housing away from the elastic assembly, and is wound along the support mechanism to a surface of the stationary housing close to the elastic assembly, and the flexible display panel is capable of sliding relative to the sliding housing.

17. The slide winding display device according to claim 16, wherein the slide winding display device further comprises a flexible support plate, the flexible support plate is fixed on the flexible display panel, and the flexible support plate is partially arranged between the support mechanism and the flexible display panel, and is partially arranged between the sliding housing and the flexible display panel.

18. The slide winding display device according to claim 16, wherein the snap-fit connecting assembly comprises a first snap-fit connecting member and a second snap-fit connecting member, one of the first snap-fit connecting member and the second snap-fit connecting member is arranged on one of edges of the flexible display panel that are along the second direction, and another one of the first snap-fit connecting member and the second snap-fit connecting member is arranged on the stationary housing or another one of the edges of the flexible display panel that are along the second direction.
